(19) United States
(12) Patent Application Publication
(10) Pub. No.: US 2006/0224729 A1
(43) Pub. Date: Oct. 5, 2006

(54) Referral tracking

(75) Inventors: Timothy D. Rowe, Cambridge, MA (US); Stanley M. Ward II, South Hamilton, MA (US); John G. Norman, Cambridge, MA (US)

Correspondence Address: FOLEY HOAG, LLP;PATENT GROUP, WORLD TRADE CENTER WEST, 155 SEAPORT BLVD, BOSTON, MA, 02110, US

(73) Assignee: H Three, Inc., Cambridge, MA (US)

(21) Appl. No.: 11/212,265

(22) Filed: Aug. 26, 2005

Related U.S. Application Data
(63) Continuation-in-part of application No. 11/092,397, filed on Mar. 29, 2005.

(51) Int. Cl. G06F 15/173

(52) U.S. Cl. 709/224

(57) ABSTRACT

A computer system is configured as a referral-tracking system that responds to receipt of a listing from a recruiter by generating an identifier, associating it with that listing, and giving it to the recruiter. If, before the listing is withdrawn, the system thereafter receives from a requester a message offering to forward the listing and incorporating that identifier or another identifier that the system has associated with that listing, it generates a further identifier as a child of the received identifier, associates that further identifier with the listing and the requester, and sends it to the requester. Consequently, if the listing is fulfilled by someone identified to the system as having received a message that incorporated one of those identifiers, the system determines that identifier's ancestors and thereby compute the chain of referring requesters that led to the listing's being fulfilled. It can also compute an appropriate incentive-award distribution to the referring requesters.

### CROSS-REFERENCE TO RELATED APPLICATION

The present application is a continuation-in-part of commonly assigned copending U.S. patent application Ser. No. 11/092397, which was filed on Mar. 29, 2005, by Rowe et al. for Referral Tracking and is hereby incorporated by reference.

### BACKGROUND OF THE INVENTION

1. Field of the Invention

This disclosure relates to the representation and tracking of personal-contact networks used to propagate listings and referrals of listings.

2. Background Information

Widely disseminated but relatively indiscriminate media such as newspapers are often used to elicit offers to take a job, make an investment, buy property, etc. But the most effective and efficient way to elicit interest often turns out to be the use of personal-referral networks: acquaintances communicate an opportunity's availability selectively to people they know. Recognizing this, many enterprises disseminate job listings to their contacts, such as existing employees, and provide incentives, such as employee-referral bonuses for identifying successful candidates.

The Internet and other computer networks have enhanced that approach's efficiency, and network services have evolved that employ that approach. In one type of service, for example, a person wishing to create and propagate a listing (such as a recruiter who wants to elicit job applicants) uploads the listing to a central server. The recruiter also sends the central server a list of e-mail addresses of some of the recruiter's contacts, and the server thereupon sends those contacts messages that describe the listing and give the URL of a web page where the messages' recipients can express interest in the offer, and/or provide the e-mail addresses of some of their own contacts—to whom the central server further propagates the listing.

Such services lend the speed of Internet communication to the targeted propagation of personal referrals. Moreover, since the central server receives the referrals and sends the resultant offer-eliciting messages, such services can provide an automated way of implementing rewards systems and/or keeping track of which referral sources prove most effective.

### SUMMARY OF THE INVENTION

But we have recognized that it would be advantageous if such automation could be achieved without requiring that the recruiter and other referring parties provide their contacts to the central server, and we have devised a way to do so. Instead of sending the central server a contact list, the recruiter or other referring party obtains from the central server an identifier value that the central server associates uniquely with the combination of listing and referrer. Then, instead of having the central server send the listing-containing message, the referrer can send the message directly (for example, via his or her own e-mail system) and include the identifier in the message. When the recipient wants to inform one of his own contacts of the listing—and get credit for doing so—he requests his own unique identifier from the server and includes in the request the identifier he received from the referrer. In issuing the new identifier, the central server can link the new identifier with the identifier the recipient submitted and thereby track the referral chain. A recipient who instead wants to express interest in the listing—e.g., apply for the job—similarly includes the referrer-supplied identifier in an application that he sends the central server for that purpose.

This approach has several advantages. First, a person who wants to propagate a listing does not have to provide the recipients' e-mail addresses to the central server. Many people highly value their personal-contact networks, which can require years of hard work to build and maintain. Users of a referral-tracking system may therefore be reluctant to pass those contacts to a third-party system, as the above-described conventional system requires, because, for example, they fear inundating their colleagues and acquaintances with unsolicited e-mails from strangers. Our invention can be so implemented that the recipient can refrain from identifying himself to the central server unless he wants to fulfill the listing or get credit for forwarding the listing to others. Moreover, in most embodiments of the invention a user will use his e-mail client's address book to address e-mail messages to his contacts, which is easier than copying names and e-mail addresses into the central server's interface as the conventional approach requires. Finally, in a system that employs the present invention's teachings, the listing tends to come from someone the recipient knows, so he is far more likely to respond to it or pass it along than he would be in conventional systems where the listing comes from the central server. In contrast, even if the listing e-mail sent from a conventional service's central server identifies the person who uploaded the recipient's e-mail address, the recipient may not recognize the central server's return address and may therefore ignore the message. If the central server alters the message's “from” field to make it appear that the message comes from the recipient's known contact, the message may be blocked by spam filters. Thus it is advantageous for referral e-mails to come directly from known contacts.

Further advantages will be appreciated from the following description.

### BRIEF DESCRIPTION OF THE DRAWINGS

The invention description below refers to the accompanying drawings, of which:

FIG. 1 is a block diagram of a one type of workstation that a computer system implementing the present invention's teachings may include;

FIG. 2 is a screen capture of an exemplary embodiment of a web page for entering information about a listing;

FIG. 3 is a screen capture of an exemplary embodiment of a web page for entering information about a reward associated with a listing;

FIG. 4 is a flow chart illustrating an exemplary process by which a referral-tracking system responds to the entry of a listing;

FIG. 5 is an illustration of an exemplary embodiment of data tables in which a referral-tracking system stores user identifiers, listing identifiers, and referral identifiers;

FIG. 6 is a screen capture of an exemplary embodiment of a voucher e-mail containing a referral identifier incorporated in a URL embedded in a hyperlink in the voucher e-mail;

FIG. 7 is a screen capture of an exemplary embodiment of a web page with information and instructions presented to a recruiter when a message incorporating a referral identifier has been sent to the recruiter.

FIG. 8 is a screen capture of an exemplary embodiment of a web page presented to a requester who sends the referral-tracking system a message incorporating a referral identifier;

FIG. 9 is a screen capture of an exemplary embodiment of a further web page presented to a requester who sends the referral-tracking system a message incorporating a referral identifier;

FIG. 10 is a screen capture of an exemplary embodiment of a web page for entering information about a requester;

FIG. 11 is a flow chart illustrating an exemplary process by which a referral-tracking system responds to the receipt of a message from a requester;

FIG. 12 is a screen capture of an exemplary embodiment of a web page with information and instructions presented to a requester when a message incorporating a referral identifier has been sent to the requester.

FIG. 13 is a screen capture of an exemplary embodiment of a web page on which a requester can express interest in a listing;

FIG. 14 is a screen capture of an exemplary embodiment of an e-mail confirming that a requester has expressed interest in a listing;

FIG. 15 is a screen capture of an exemplary embodiment of a web page indicating that a recruiter has been notified of a requester's interest in a listing;

FIG. 16 is a screen capture of an exemplary web page for use when a recruiter is sent a referral identifier in a web page rather than in an e-mail message;

FIG. 17 is a screen capture of a web page for providing the referral identifier to subsequent recipients;

FIG. 18 is a flow chart of alternative routines that a referral-tracking system can use to respond to a user's entering a listing; and

FIG. 19 is a flow chart of further alternative routines that a referral-tracking system can use to respond to a user's entering a listing.

### DETAILED DESCRIPTION OF ILLUSTRATIVE EMBODIMENTS

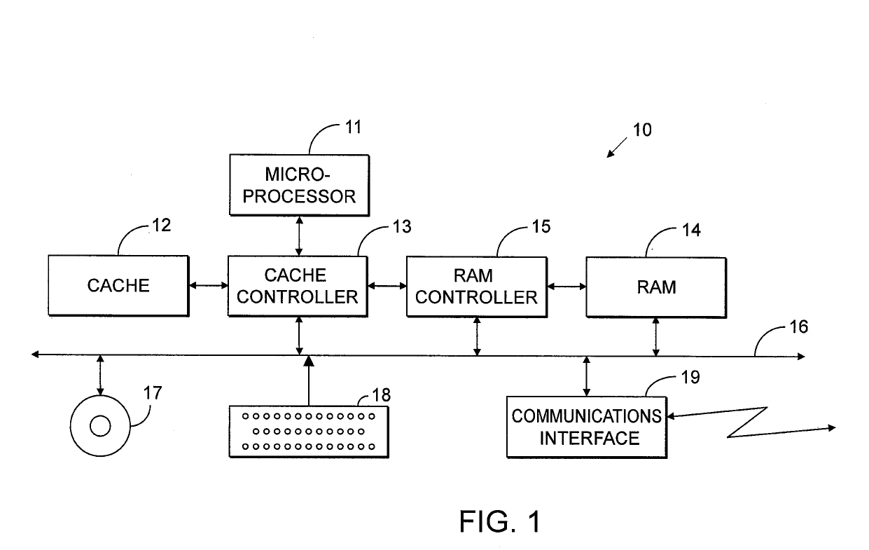

Referral-tracking approaches that employ the present invention's teachings will ordinarily be implemented in computer systems. Computer systems vary widely in architecture, so although FIG. 1 depicts one type of workstation 10 that such a computer system may include, most will differ from it in one or more details.

Data that a microprocessor 11 uses and instructions for operating on them may reside in on-board cache memory or be received from further cache memory 12, possibly through the mediation of a cache controller 13. That controller 13 can in turn receive such data and instructions from system read/write memory (“RAM”) 14 through a RAM controller 15 or from various peripheral devices through a system bus 16. The memory space made available to an application program may be “virtual” in the sense that it may actually be considerably larger than RAM 14 provides. So the RAM contents are often swapped to and from a system disk 17.

Additionally, the actual physical operations performed to access some of the most-recently visited parts of the process's address space often will actually be performed in the cache 12 or in a cache on board microprocessor 11 rather than on the RAM 14. Those caches would swap data and instructions with the RAM 14 just as RAM 14 and system disk 17 do with each other.

Independently of the particular memory arrangement that a particular workstation employs, it will often include some type of user-input device such as a keyboard 18 or mouse (not shown). By using such devices, the user enters data and commands as appropriate.

The computer system may include more than one such microprocessor, and a given one of the microprocessors may share some or all of the persistent-storage facilities with one or more other such microprocessors. The persistent-storage facilities will typically store the instructions that configure the computer system as the referral-tracking system described below, but such instructions, possibly of the type to be executed by a virtual machine that the computer system can be software-configured to implement, can in principle be loaded directly into memory from a remote source through a communications interface 19. One or more processors may use one or more such communications interfaces to implement the central-server function described below.

The referral-tracking system described herein may be employed to propagate or distribute any kind of listing or offer through the personal-contact networks of the listing's originator and recipients. For example, such a listing may be a job listing, created by a recruiter or hiring manager searching for an employee to fill a position. Alternatively, a listing may be created by a person seeking a contractor to provide a specified service. A listing may instead relate to real estate or other property, such as antiques or collectibles, offered for sale or rent by an owner, seller, or broker. Or it may be created by a prospective buyer seeking an opportunity to make an offer on real estate or other property. The referral-tracking system described may be employed in any instance in which an originator of a listing wishes to distribute any kind of offer, request, or opportunity through his or her own personal-contact network and the personal-contact networks of the listing's recipients. The above examples should be understood to be exemplary rather than exhaustive.

The following description of an exemplary embodiment of the system presents an example in which the originator of the listing is an employer or the agent of an employer seeking to fill a job position. In the example, the “listing” represents the job position to be filled. A recipient of the listing may choose to express interest in applying for the job position himself or herself and/or may choose to refer others who may be interested in applying for the position. This example can be extended to any other situation, such as those described above, in which the originator of a listing of any kind wishes to distribute the listing. In some cases the person or other entity that originates the listing is not the same as the person who decides which applicant will be chosen to fulfill the listing, and both may be different from the person or entity that issues any resultant awards. However, the description below will use the term “recruiter” collectively to refer to the entity or entities that perform one or more of such functions.

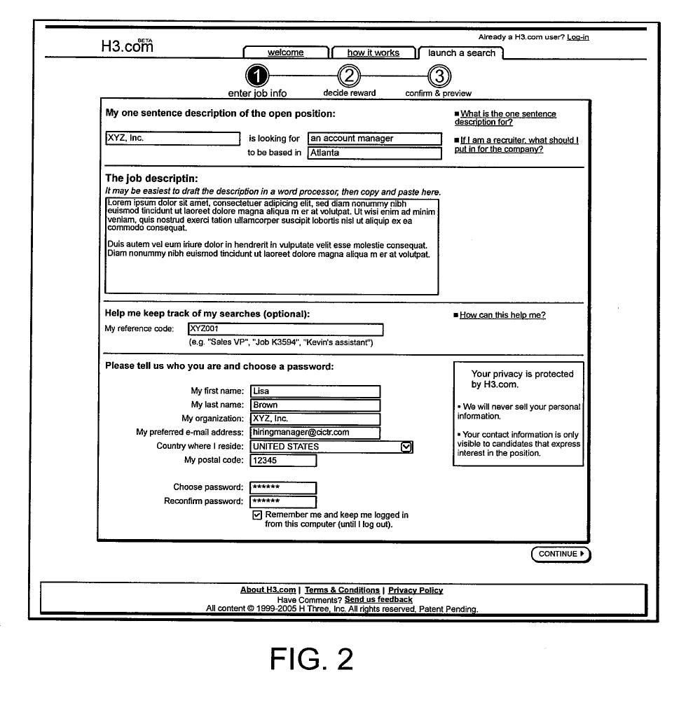

In an exemplary embodiment, a recruiter can access the referral-tracking system via the internet and, using a web-page interface, create a listing that the recruiter wants to propagate. FIG. 2 depicts an example of web-page interface for creating a listing. In alternative embodiments, the recruiter may supply information about the listing by sending e-mail or any other transmission to the referral-tracking system. The e-mail message may, for example, be a form e-mail from which the referral-tracking system can automatically read information about the listing. For the purposes of the present discussion, any information about the listing received by the referral-tracking system in any way, including via a web-page interface or via e-mail, is considered a listing-containing “message” from a recruiter.

A listing may include information about the organization or person on whose behalf the listing is created, e.g., an employer having a job opening. The listing may also include a job title and/or a brief description of the job as well as the job's geographical location and any other information pertinent to the offer described. The recruiter may also assign the listing a reference code that is to be included in further communication about the listing between the recruiter and the referral-tracking system.

As FIG. 2 shows, the referral-tracking system may also include a means for collecting information about the recruiter such as the recruiter's name, address, and e-mail address. In one embodiment, the referral-tracking system may create an account unique to the particular recruiter. To edit or retrieve information pertaining to any listing that the recruiter has created, the recruiter may subsequently access his or her account by using a password. The referral-tracking system may also create an identifier associated with the recruiter.

In an exemplary embodiment, there may be a reward associated with a listing. The reward may be offered, for example, by the organization or person on whose behalf the listing is created. In the case of a job listing the reward would typically be awarded when a listed position is filled successfully through the referral-tracking system. If a listing invites applicants for more than one job position, a reward may be distributed each time a referred candidate is hired for a listed position. As will be described below, that system may determine which requesters will receive a share of the reward.

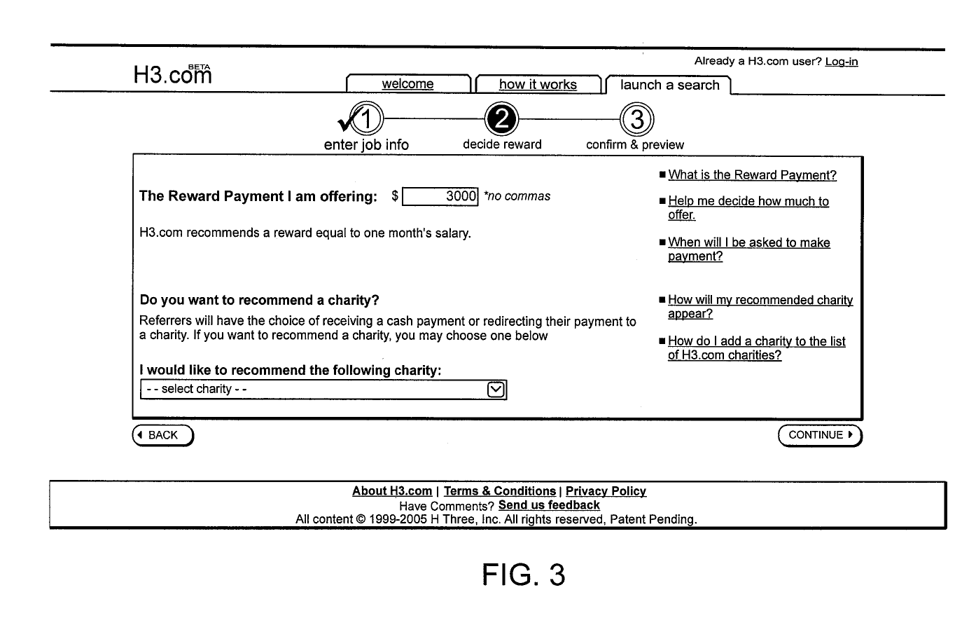

The referral-tracking system may enable the recruiter to submit a reward amount with the listing. FIG. 3 depicts an exemplary web-page interface that can be used for that purpose. In the illustrated embodiment, a recipient who qualifies for a share of the reward has the option of accepting payment of the share of the reward or of redirecting that payment to a charity. In the embodiment illustrated in FIG. 3, the referral-tracking system allows the recruiter to recommend a charity to which the reward should be directed. The recruiter selects the recommended charity from a list of charities that referral-tracking system provides.

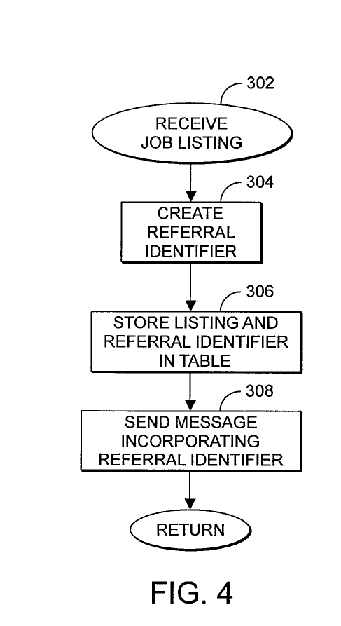

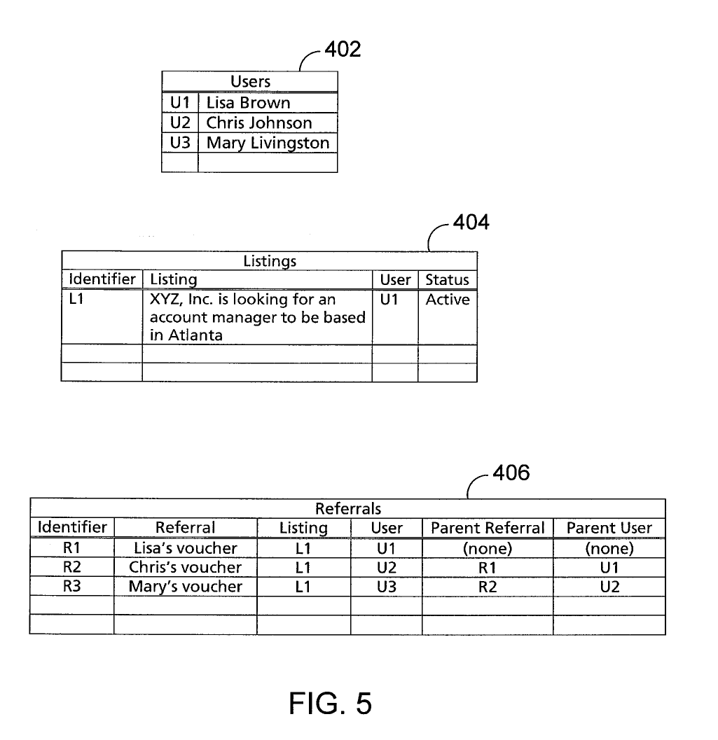

FIG. 4 is a flow chart that depicts how the illustrated embodiment responds when it receives a listing from a recruiter. Once the recruiter has finished entering information about the listing and any associated reward (block 302), the exemplary referral-tracking system generates a referral identifier associated with the listing (block 304) and stores it with the information about the recruiter, the listing, and/or the reward (block 306). FIG. 5 illustrates exemplary data tables in which the referral-tracking system may store referral identifiers and associated listing information. In the example of FIG. 5, the referral-tracking system maintains a table 402 in which it associates identifiers with respective users of the system. It may have generated those identifiers, for example, as Universally Unique Identifiers (UUIDs). The referral-tracking system may further maintain a table 404 of identifiers associated with each listing entered by a recruiter. In the illustrated example, that table also includes other information about the listing, such as the identity of the user who created it, its status, etc. The referral-tracking system may also maintain a table 406 that associates identifiers with referrals. In the example, table 406 relates each referral identifier to any users, listings, or parent identifiers with which the referral identifier is associated. Thus, in the example illustrated in FIG. 5, a user identifier U1 is created corresponding to the recruiter Lisa Brown; a listing identifier L1 is created for the listing entered by Lisa Brown seeking an account manager for XYZ, Inc.; and a referral identifier R1 is created and associated with the identifiers L1 and U1.

The referral-tracking system then provides the referral identifier to the recruiter. As will be seen, the recruiter will in turn supply that referral identifier to contacts whom he wants to enlist in identifying a candidate for the job. The intention is that, if the contact wants to participate in the search and get credit for doing so, he will identify himself to the central server, submit the identifier he received, and be issued a further identifier, which the central server will associate with that contact and treat as a child of the identifier the contact submitted. Subsequent identifier recipients will do the same, and through the parent-child relationships thereby established, the system can track referral chains and identify the one that ultimately results in the job being filled.

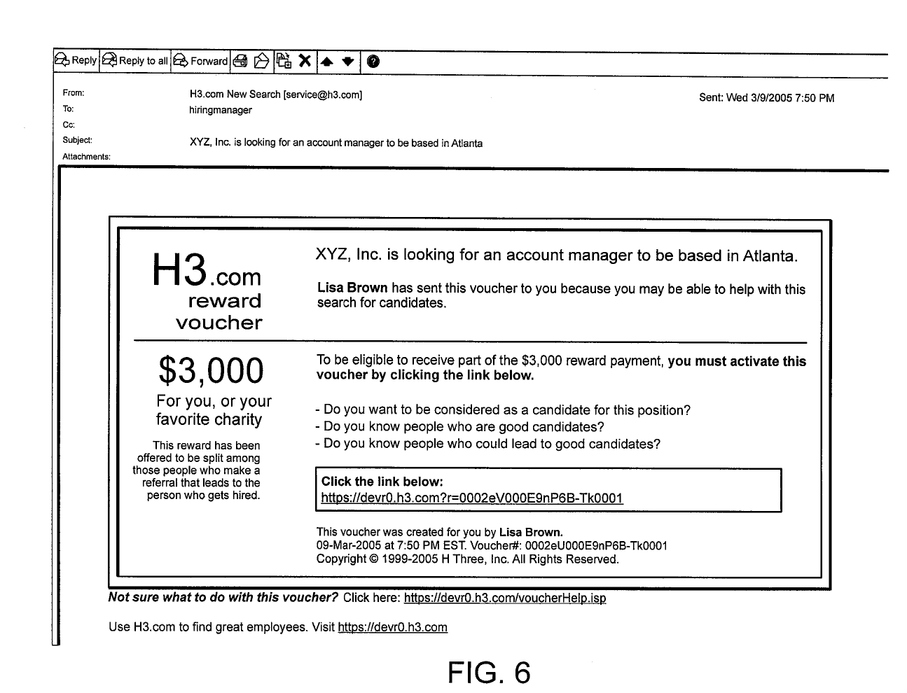

To facilitate that behavior, the illustrated embodiment sends the recruiter an e-mail message, as block 308 indicates, containing a Uniform Resource Locator (“URL”) that incorporates the referral identifier. In particular, the illustrated embodiment includes that URL in the reference field of a hyperlink, which typically also displays that URL explicitly. FIG. 6 illustrates an embodiment of a message, sent to a recruiter, containing the URL https://devr0.h3.com?r=0002eU000EgnPb6B-Tk0001. We assume for the sake of this example that 0002eU000EgnPb6B-Tk0001 is the referral identifier that the system generated when Lisa Brown entered the listing; i.e., the illustrated embodiment incorporates that identifier by simply including it literally without transformation in the URL as the value of a parameter named “r.”

But not all embodiments that incorporate the referral identifier in a URL will necessarily embed it in a hyperlink. In some, for example, an e-mail message may simply include a plain-text URL for the recipient to copy and paste into the address bar of a web browser. Further, the URL may contain the referral identifier explicitly or in any transformed, transposed, or other form from which the referral identifier can be inferred. For the purposes of this discussion, a message of any kind (including information passed via a web-page interface or via e-mail), a URL, or a hyperlink “incorporating” or that “incorporates” a referral identifier should be understood to include that referral identifier, or any form from which it can be inferred.

Also, although the illustrated embodiment employs only a single parameter to incorporate the referral identifier, some embodiments that incorporate the referral identifier in a URL may employ a plurality of parameters collectively for that purpose. Instead of generating a separate UUID as the identifier for a given referral, for example, some embodiments may use as the referral identifier a (listing ID, user ID) pair or a (listing ID, user ID, parent ID) triple (in which the parent ID would be a reserved null value if the user is the originator). In such embodiments, it may prove convenient to use separate parameters for respective components of the (composite) referral identifier.

And parameters are not the only way to incorporate a referral identifier in a URL. For example, some systems may provide a separate server page for each listing, in which case the listing component of a composite referral identifier could be represented by the name of that page, while the user component would probably still be passed as a parameter. Such a URL could look something like “http://serverName.com/XYZ_AccountManager.asp?u=0002eU000EgnPb6B-Tk0001.”

In the illustrated embodiment, the message that contains the hyperlink incorporating the referral identifier is configured to appear as a “voucher” such as the one that FIG. 6 illustrates. For the purposes of this discussion, the term “voucher e-mail” will refer to a message that incorporates a referral identifier associated with the listing. It should be understood that the term “voucher e-mail” refers to any such message, regardless of whether it is configured to appear as a voucher such as the one that FIG. 6 illustrates. A voucher e-mail may contain all or some of the recruiter-entered information about the listing. The voucher e-mail may also contain information about any reward offered by the recruiter or the organization or person on whose behalf the listing was created. In the example of FIG. 5, the referral-tracking system sends “Lisa's voucher” containing referral identifier R1 to Lisa.

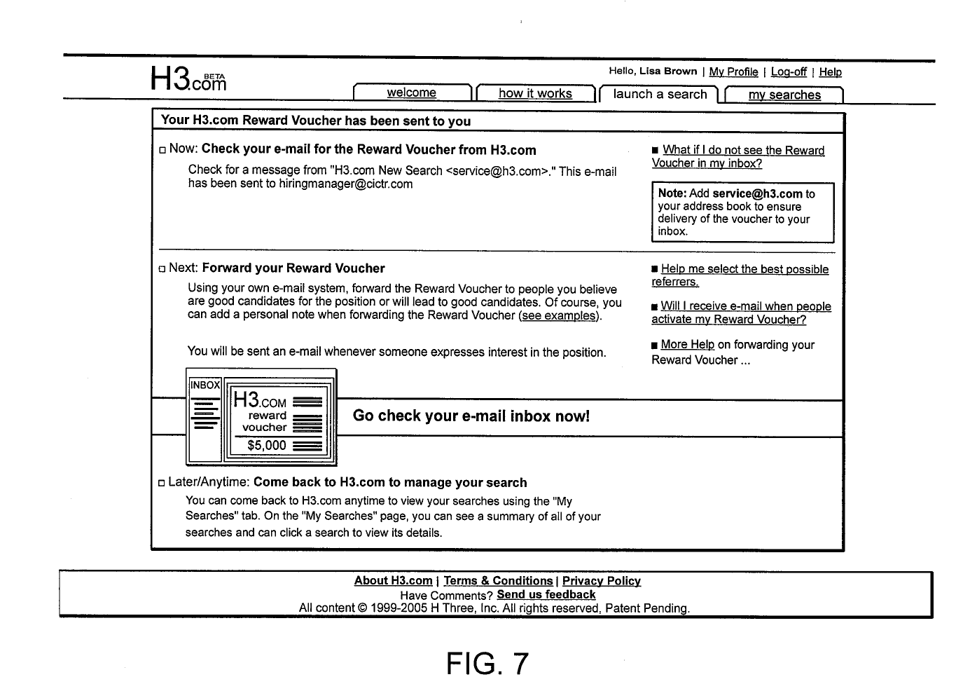

In the illustrated embodiment, when the referral-tracking system sends the voucher e-mail to the recruiter, it may also provide the recruiter a web page such as the one pictured in FIG. 7, providing the recruiter with additional information and instructions, including the option to view information about the listing.

When the recruiter receives the voucher e-mail, he or she can then send it using his or her own e-mail system to any number of recipients who may be interested in the listing or know someone who is. These recipients may be selected from the recruiter's own personal contacts. Note that this allows the recruiter to protect his or her personal-contact network by forwarding the listing without having to provide recipients' e-mail addresses to the referral-tracking system. The referral-tracking system need not receive the identities or e-mail addresses of the recipients that the recruiter has chosen unless the recipients decide to identify themselves to the referral-tracking system in order to apply for the job or get credit for a referral.

For the purposes of this description, the term “requester” will refer to a recipient who submits a referral identifier he has received and requests a child referral identifier by providing the received referral identifier to the referral-tracking system. In addition, although recipients will be described in connection with the illustrated embodiment as clicking on the hyperlink to submit to the referral-tracking system the identifiers they receive, other embodiments may additionally or instead accept other modes of submission. For example, the recipient may copy a URL into a web browser's address bar or send an e-mail message. Or a plug-in module in the client's e-mail client may detect a referral-tracking-system message, respond to such a message's receipt by presenting the user the options that, as will be described below, the illustrated embodiment's web page does, and respond to a resultant user input by sending the system the received identifier and the user's information, possibly without the user's having to enter that information manually.

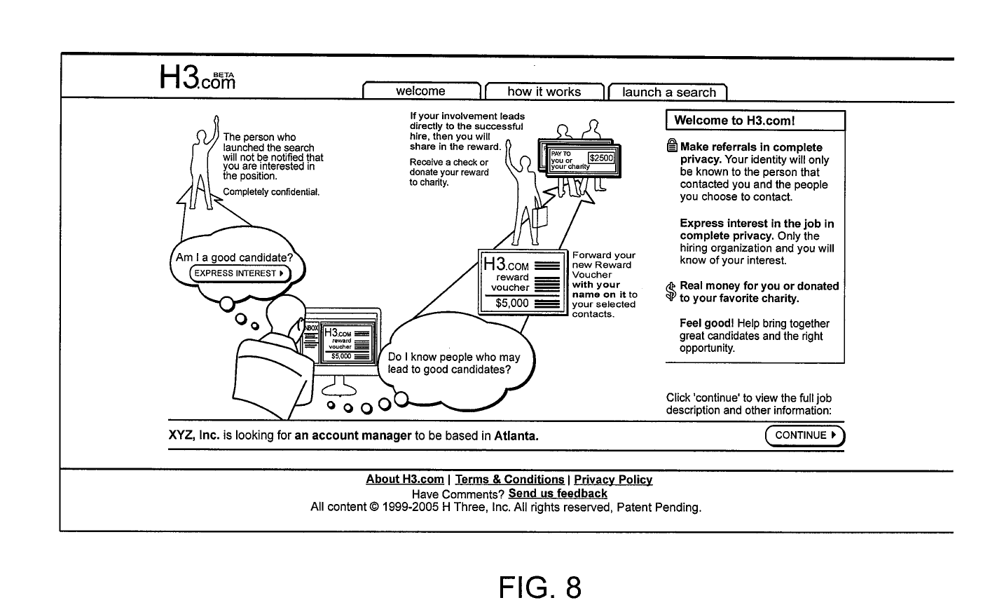

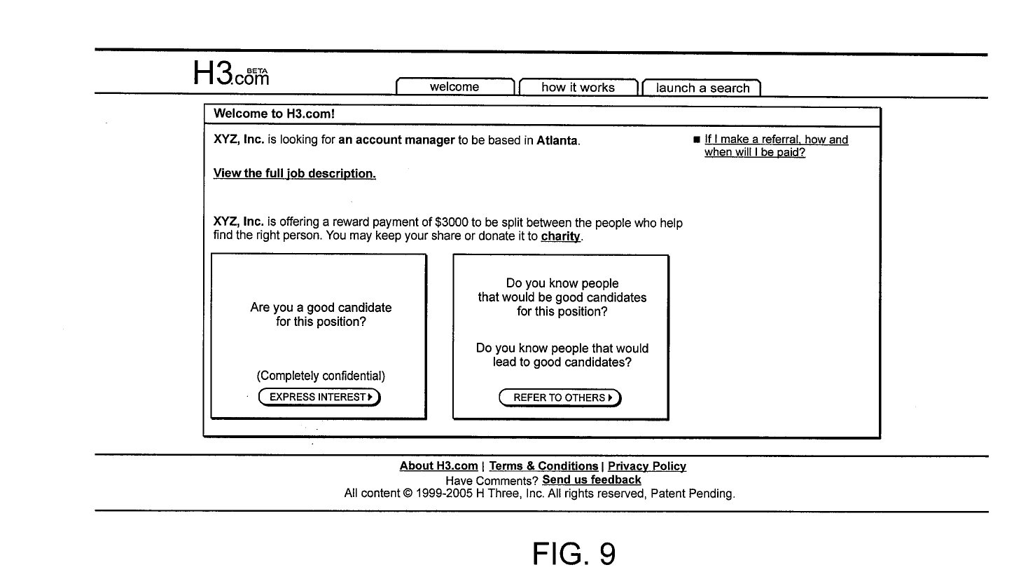

In the illustrated example, though, the requester clicks on a hyperlink contained in a forwarded voucher e-mail, and the requester's web browser sends the referral-tracking system a message that contains (either explicitly or in encoded form) the referral identifier incorporated in that hyperlink. In response to that message, the illustrated referral-tracking system sends the requester a web page offering the requester the choice either to express interest in the listing or to make referrals, i.e., to refer the listing to other recipients. FIGS. 8 and 9 depict examples of web pages that can be used for this purpose. The web page illustrated in FIG. 8 explains the choices. When the user loads that page, he clicks its “continue” button and thereby summons the page that FIG. 9 depicts. That page provides buttons on which the requester can click to make his or her selection. In some embodiments, the requester may be provided with the option of both expressing interest in the listing and making further referrals.

In some embodiments, rather than providing the requester with a single hyperlink that directs the requester to a web page presenting options to the requester, the voucher e-mail may itself be configured to provide the requester with multiple options, such as expressing in the listing, offering to make referrals, or both. For example, the voucher e-mail may include multiple URLs, each incorporating a referral identifier along with an additional parameter corresponding to a respective one of the choices presented to the requester. These URLs may be provided in the voucher e-mail in plain text or embedded in hyperlinks, including hyperlinks having an image attribute so that they appear as buttons or other icons in the voucher e-mail. Clicking on such a URL sends a message to the referral-tracking system that incorporates the referral identifier along with an indication of the choice the requester has thereby made.

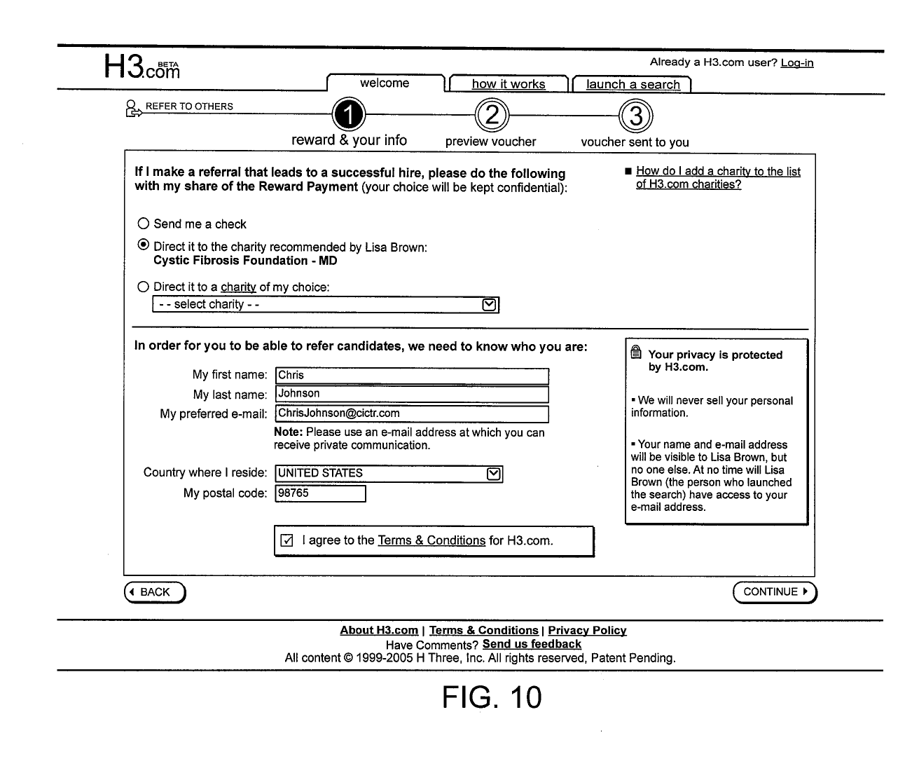

Upon receiving from the requester a message incorporating a referral identifier, the referral-tracking system determines whether the requester already exists in its data-base of users. The system may make this determination by, for example, reading a cookie on the requester's computer or comparing information collected from the requester with information in its database. As illustrated in FIG. 5, the identifier associated with the requester (U2) may be stored with other user identifiers in data table 402. In an exemplary embodiment, if the requester is a new user, the referral-tracking system collects information about the requester by using a web-page interface such as the one that FIG. 10 illustrates. In an embodiment in which a reward is associated with the listing and in which a requester qualifying for a reward has the option to direct the reward payment to a charity, the referral-tracking system may, as FIG. 10 illustrates, also collect information from the requester about which charity should receive any reward for which the requester qualifies.

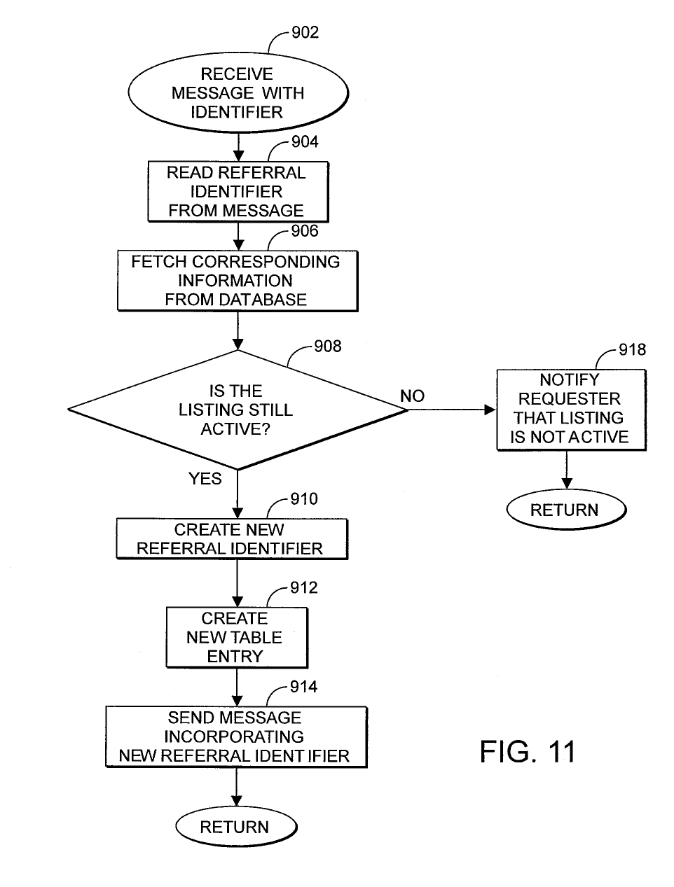

If the requester's selected option is to make referrals, the referral-tracking system may execute a routine like the one that the flow chart of FIG. 11 illustrates. In block 904, the referral-tracking system reads the identifier contained in the message it received. As block 906 indicates, the referral-tracking system then retrieves the information associated with that identifier, for example from data tables 402, 404, and/or 406 illustrated in FIG. 5. In that example, if Lisa Brown forwards “Lisa's voucher” to Chris, and Chris clicks on the hyperlink incorporating referral identifier R1 in Lisa's voucher, the referral-tracking system will retrieve the listing information associated with listing identifier L1. If Chris is unknown to the referral-tracking system, it will collect information from him and create new user identifier U2.

As block 908 indicates, the referral-tracking system may then check the status of the listing to determine whether the listing is still active. A listing may become inactive when, for example, it is withdrawn by the recruiter (because, e.g., all offered jobs have been filled, all offered items sold, etc.). If the listing is active, the referral-tracking system proceeds to block 910, generating a new referral identifier and associating it with the listing, with the identity of the requester, and with its parent identifier, namely, the identifier that was read in block 904. (Actually, it can simplify processing in some respects to restrict any given user to a single referral identifier for a given listing, so some embodiments may not generate a new identifier if the requester has already been issued one for the listing in question, but the flow chart does not depict this feature.) As block 912 indicates, the new referral identifier is stored with its associated information, possibly in a table such as FIG. 5's data table 406. In the example of FIG. 5, the new referral identifier R2 is associated with the listing identifier L1 (corresponding to the listing), the user identifier U2 (corresponding to Chris), and the parent referral identifier R1 (which Lisa's voucher contained) by entering L1 and R1 in R2's table entry. Of course, those skilled in the art are familiar with many other ways others of recording child-parent relationships between objects, and some other embodiments may employ such other ways to designate the new identifier as a child of a previous identifier.

Finally, the referral-tracking system sends the requester a message that incorporates the new referral identifier. FIG. 11's block 914 represents that operation. The message may, for example, be a voucher e-mail incorporating the new referral identifier. In the example of FIG. 5, the new voucher is “Chris's voucher,” containing a hyperlink incorporating referral identifier R2. The requester can then send the new voucher e-mail to any number of recipients who may be interested in the listing or know someone who is. These recipients may be selected from the requester's own personal contacts. This, again, allows the requester to select from his or her own address book those individuals who the requester believes would have interest in the listing and to refer them without the need to provide their contact information to the referral-tracking system. Thus, the requester can refer listings without compromising the confidentiality of his or her own personal-contact network.

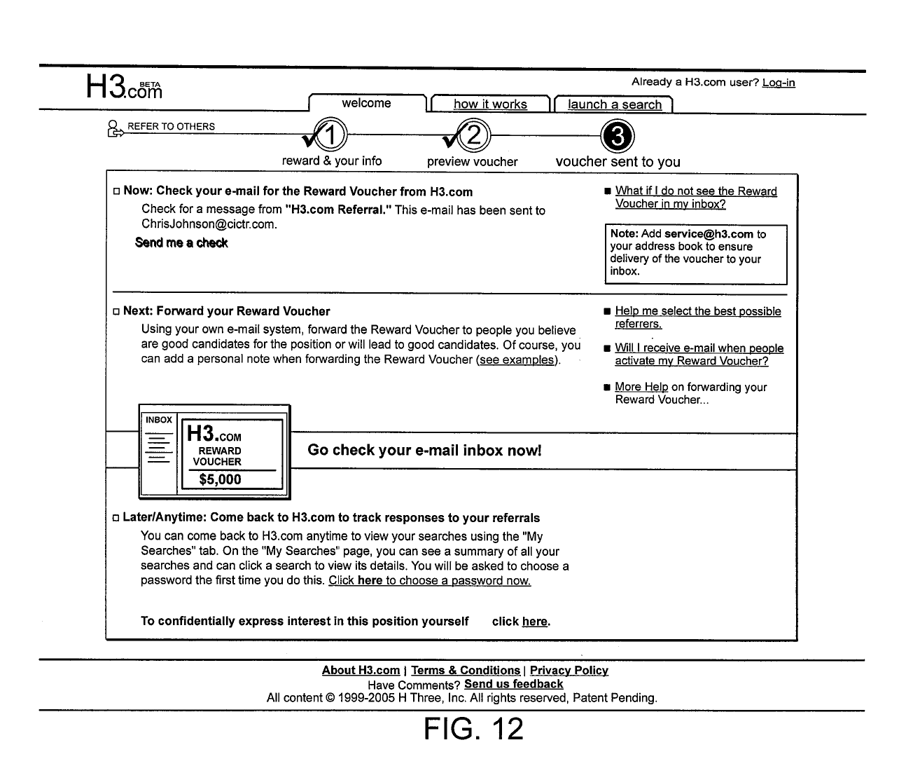

In the illustrated embodiment, when the referral-tracking system sends the voucher e-mail to the requester, the referral-tracking system may provide a web page, such as the one pictured in FIG. 12, that gives the requester additional information and instructions.

In the example illustrated in FIG. 5, Chris can forward “Chris's voucher” to Mary without providing Mary's contact information either to the referral-tracking system or to Lisa. If Mary then clicks on the hyperlink in Chris's voucher, the routine illustrated in FIG. 11 is again invoked, and a new referral identifier R3 is created and associated with listing identifier L1 (associated with Lisa's listing), user identifier U3 (associated with Mary), and parent referral identifier R2 (associated with Chris's voucher). Mary, in turn, may choose to express interest in the listing and/or to request a voucher e-mail incorporating referral identifier R3 that she can use to refer the listing to still other recipients.

As is apparent from FIG. 5's table 406, referral chains are generated as requesters click on hyperlinks contained in forwarded voucher e-mails. If a requester clicks on a hyperlink that incorporates a referral identifier and the referral-tracking system accepts that requester as a new referrer, the referral-tracking system generates as a child of that referral identifier a new referral identifier associated with the listing and that requester. As was observed above, referral-identifier generation in some embodiments may not always involve creating a new UUID for each new referrer or applicant, as the illustrated embodiment does; it may, for instance, merely comprise combining different existing component identifiers. And the present invention's teachings do not require that the stored information be organized in tables or that any tables that are used be arranged as those of FIG. 5 are. But every embodiment will take the information in some way that enables it to track a respective chain of referrals from each recipient back to the initial issuance of an identifier associated with the listing.

Still, different embodiments may infer different topologies from the same set of user actions. This can result from differing approaches to enforcing identifier uniqueness, or, viewed another way, to what a referral is considered to be.

To appreciate this, consider as a first embodiment a referral-tracking system that supports the following operational scenario. First, an originator, O, is issued referral identifier R1 and sends it to acquaintances A and B. Second, A uses referral identifier R1 to obtain his own identifier, is accordingly issued referral identifier R2 as a child of R1, and sends it to acquaintance B. Third, B (reading his topmost e-mail message, the one from A) uses referral identifier R2 to obtain his own referral identifier R3 as a child of R2 and sends it to acquaintance C. Fourth, B (after thereafter reading the lower-down e-mail message from O) uses referral identifier R1 to obtain referral identifier R4 as a child of R1 and sends it to D, who takes the job.

For the sake of example, we assume here that the referral-tracking system uses referral tables of the type that FIG. 5 depicts. The actions just described cause the first embodiment under consideration to place four entries into the referral table, namely, a respective entry for each of the referral identifiers R1, R2, R3, and R4. Note that, although each referral identifier is associated with a corresponding user and listing, the associations of user-listing combinations with identifiers is not unique; the entries for R3 and R4 have the same user-listing combination. In this first embodiment, that is, the concept of referral can be thought of a coupled only loosely to that of which user is doing the referring. And, without more, the referral chain would be deemed to be O-B-D, because R1 is the parent of R4, which is the identifier that D received: B alone would get the reward (if the originator cannot share).

Other embodiments may be so arranged as to couple the concepts of referral and referrer more tightly. For example, consider as a second example embodiment one whose response to B's second request—i.e., to a request for a second referral identifier associated with the same combination of user and listing—would be to deny the request or, what amounts to the same thing, just send B the same referral identifier it sent him previously. In that case, the referral chain would be deemed to be O-A-B-D: A and B would share the reward. Note that in this embodiment the parent-child relationships between referrals are equivalent to parent-child relationships between users. To emphasize that, FIG. 5's table 406 includes a “parent user” column even though that column's information is redundant in view of the “parent identifier.”

The chains begin with the person to whom the system issues the first referral identifier. We refer here to that person as the “recruiter,” and the recruiter is Lisa in the FIG. 5 example. The next person in each chain is a requester to whom the recruiter directly sent a voucher e-mail that incorporated an identifier associated with the listing. For the sake of simplicity, FIG. 5 depicts only a single chain, and Chris is that person. Subsequent links in the chain include requesters who received voucher e-mails sent by other requesters. In the example of FIG. 5, Mary is such a requester. There may be multiple referral chains, since any requester may elect to refer the listing to multiple further recipients, each of whom may in turn refer the listing to still further recipients. As noted above, the referral-tracking system maintains a database of all identifiers associated with a particular listing as well as all requesters who have either further referred or expressed interest in the listing. Such a database may further associate each referral identifier with its parent referral identifier, as illustrated in table 406 in FIG. 5.

Different embodiments may differ in how much information they share with the recruiter. For example, by logging in to the referral-tracking system and reviewing the status of the listing, the recruiter may be provided with information about the number of times the listing was referred (i.e., the number of child referral identifiers generated), but not the names of the requesters who referred the listing. In another exemplary embodiment, the recruiter may be shown the names of the requesters directly linked to the recruiter, but not the names of requesters further along the referral chains. In this way, the recruiter may obtain information about how many additional unique vouchers have been requested, while the confidentiality of subsequent requesters' contact networks is preserved. Alternatively, if confidentiality is not required, the recruiter may be shown the complete referral chains.

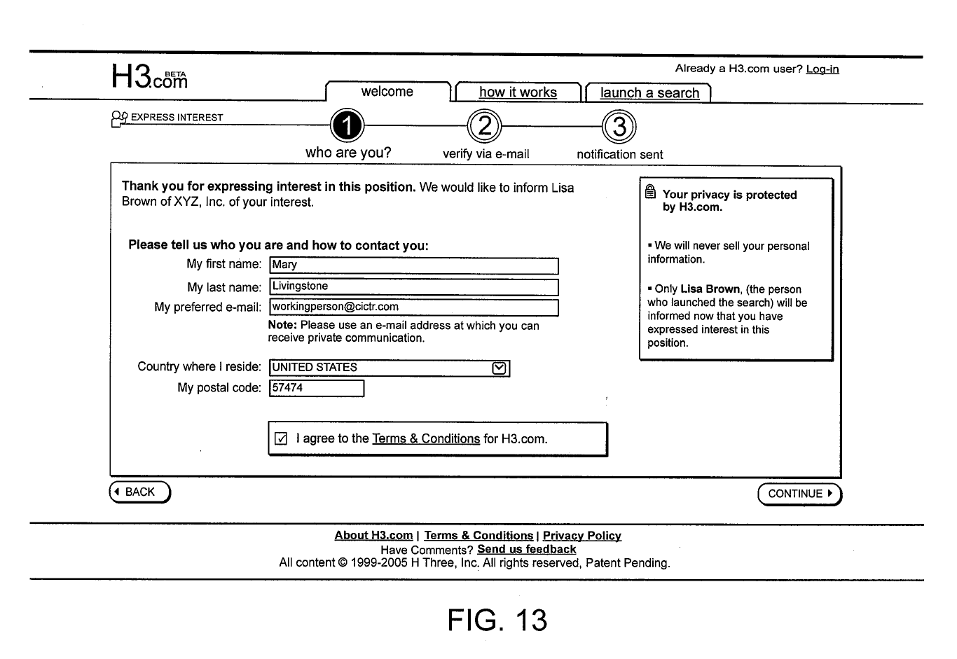

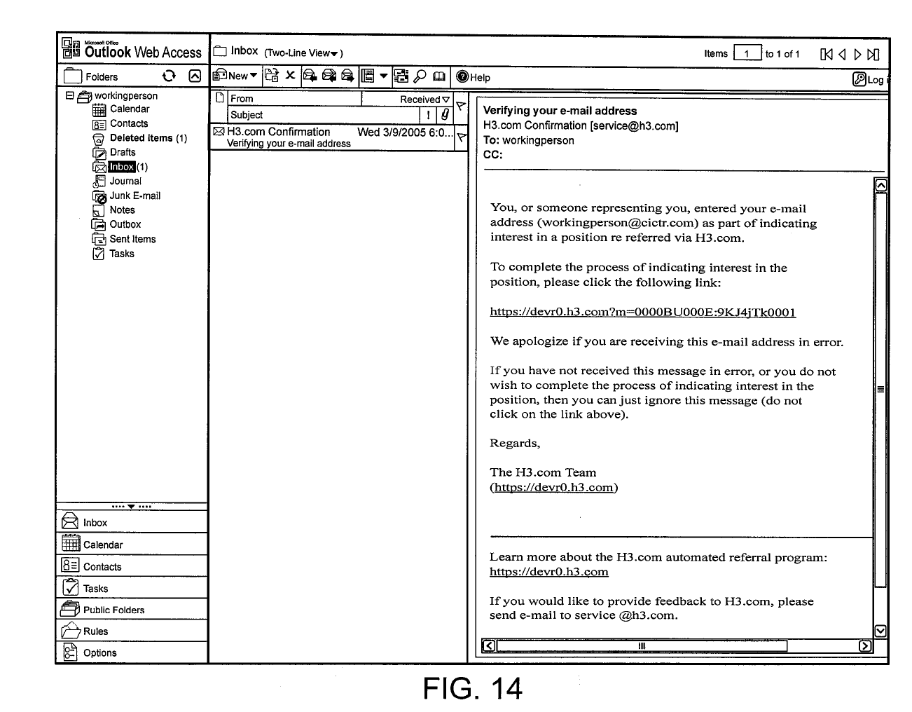

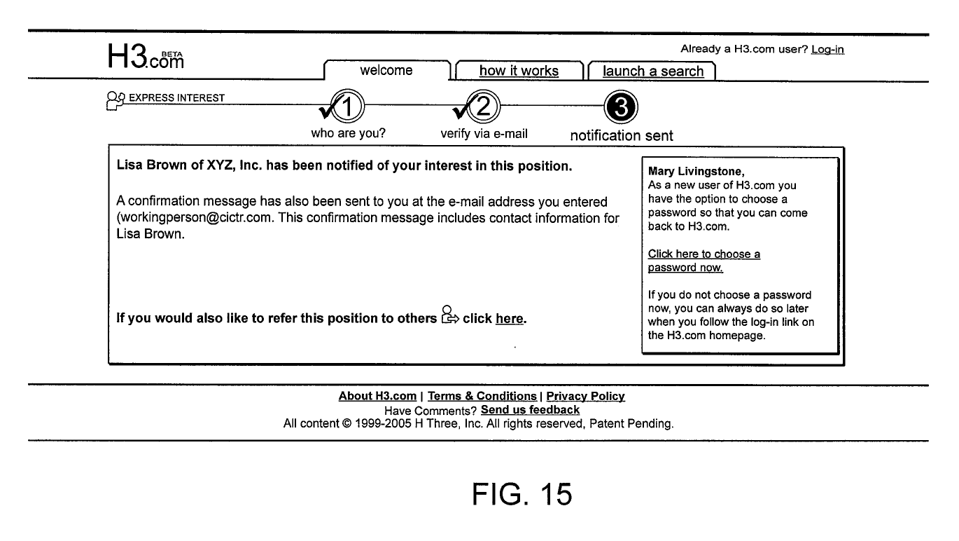

When a requester chooses to express interest in the listing (by, for example, clicking on FIG. 9's “express interest” button), the referral-tracking system may collect information about the requester to provide to the recruiter; as FIG. 13 illustrates, it provides a web-page interface for collecting such information. In an exemplary embodiment, once the referral-tracking system has collected information about the requester interested in the position, the referral-tracking system may send a confirmation e-mail to an address provided by the requester in order to confirm the requester's interest and e-mail address before notifying the recruiter of the requester's interest. The confirmation e-mail may include a hyperlink incorporating an identifier associated with the listing and the requester. (FIG. 14 depicts an exemplary confirmation e-mail.) When the requester clicks on that hyperlink (or copies its referred-to URL into the address bar of a web browser), a message is sent to the referral-tracking system that contains the incorporated identifier. Upon receipt of that message the referral-tracking system may notify the recruiter of the requester's interest in the listing by, for example, sending a notification e-mail to the recruiter. In an exemplary embodiment, the referral-tracking system provides the interested requester with a web page indicating that the recruiter has been notified of the requester's interest, as FIG. 15 illustrates. The recruiter may then contact the interested requester at the e-mail address the requester provided. In the illustrated embodiment, previous requesters are not notified that a subsequent requester has expressed interest in the listing, although they may be in other embodiments.

When the listing has been fulfilled or partially fulfilled (e.g., when some or all jobs in the listing have been filled, the listed real estate sold, etc.), the recruiter may log in to the referral-tracking system and change the status of the listing to reflect that it has been fulfilled or partially fulfilled and/or to reflect which requester took a listed position. Some embodiments may be so arranged that a requester (for example, a requester ultimately hired to fill the listed position) can claim that the status of the listing should be changed to reflect that a listed position has been taken. In such an embodiment, the referral-tracking system would typically send to the recruiter a confirmation e-mail inviting the recruiter to confirm that the listed job has been filled, and the recruiter may do that by, e.g., clicking on a hyperlink the e-mail contains or logging in to the referral-tracking system. The recruiter may also withdraw the listing or otherwise change its status for any reason at any time. For example, a recruiter may wish to temporarily suspend a search for candidates in order to have an opportunity to interview those candidates already identified. Therefore, in some embodiments, the referral-tracking system may permit the recruiter to temporarily designate a listing as inactive and at a later time change the listing's status back to active. In the illustrated embodiment, each listing entry in the data table 404 includes an entry indicating the listing's status (i.e., telling whether that listing is active, inactive, withdrawn, etc.).

As noted previously in connection with FIG. 11's block 908, when the illustrated referral-tracking system receives a referral-identifier-incorporating message from a requester, the referral-tracking system may check the status of the associated listing before it presents the requester the options of expressing interest in the listing and making referrals. If the listing status reflects that the listing has been designated inactive or withdrawn, the referral-tracking system may, as block 918 indicates, provide the requester with a message (e.g., on a web page) indicating that fact.

There are circumstances in which it is desirable for the referral-tracking system to generate a set of all user identifiers or referral identifiers in a chain leading from the recruiter to a particular requester. Such a set will be described herein as the set of “ancestors” of a given identifier. An identifier is a given identifier's ancestor if it is the given identifier's parent or an ancestor of the given identifier's parent. It may similarly be desirable for the referral-tracking system to generate a set of “offspring” identifiers in one or more chains leading from a particular requester to subsequent requesters. An identifier is a given identifier's offspring if it is the given identifier's child or an offspring of the given identifier's child.

For example, a referral-tracking system may compute the set of ancestors and/or offspring in response to a request for information about the status of the listing's referral chain. The set of ancestors and/or offspring may then be used to provide that information to the recruiter. In addition, a referral-tracking system may use a set of ancestors to determine the distribution of a reward. When the system is informed that a requester has been hired for a listed job, it is thereby at least implicitly informed of which referral chain led to that requester. When the system is informed of which applicant fulfilled the listing, it finds that applicant in that listing's applicant list and thereby identifies the referral that was the fulfillment's proximate cause. It then identifies that referral identifier's ancestors and uses the resultant ancestor set to generate an output. The system may also be arranged to generate an output based on an ancestor set and/or an offspring set for other reasons.

The output can take many forms. In some cases, for example, it may be an indication of how effective various people are as referrers. In the illustrated example, though, the output is an indication of how the reward is to be shared. The simplest approach is for each referrer listed in an ancestor referral to receive an equal share of the award. But the system may instead award unequal shares, and outside information may be relied on to arrive at the distribution. For example, the referral-tracking system may refer to a database of all requesters who have made referrals in the past, and provide eligible requesters with a share proportional to the number of listings they have previously forwarded. Any other method of apportioning shares of the reward among requesters in the branch of the referral tree connecting the recruiter to the requester who fulfilled the listing may be employed.

Occasionally, more than one referral may be identified as the proximate cause of the fulfillment: More than one branch of the referral tree may connect the recruiter to the requester who fulfilled the listing. In such a case, the reward may be distributed either to the requesters in branches leading to the requester who fulfilled the listing, or say, only among the requesters in the branch that was activated first. For example, if a recruiter forwards a voucher e-mail to requesters A and B, who both elect to forward the listing to C, C will receive two voucher e-mails: one voucher e-mail from A, containing a hyper-link incorporating an identifier associated with the listing and with A; and one voucher e-mail from B, containing a hyperlink incorporating an identifier associated with the listing and with B. If C clicks on one of the hyperlinks, elects to express interest in the listing, and eventually fulfills the listing, whether the reward goes to A or B is determined, in an exemplary embodiment, by whether the identifier incorporated in the hyperlink that C clicked on was from A's or B's branch of the tree. If C clicked on both A's and B's hyperlinks, the system may assign the reward to both branches or only to one (for example, the branch of the tree that C clicked on first).

As was stated above, the system may use a web-page interface rather than an e-mail message to send the referral identifier to the recruiter. For example, this may be done in the way that FIG. 4 depicts, with the message transmission to which block 308 refers being performed by sending the user's browser a web page that, e.g., displays the URL for the recruiter to copy and paste into one or more e-mails sent to one or more recipients to whom the recruiter wishes to refer the listing. The URL may be displayed along with additional text the recruiter may also copy and paste into e-mails sent to referred recipients.

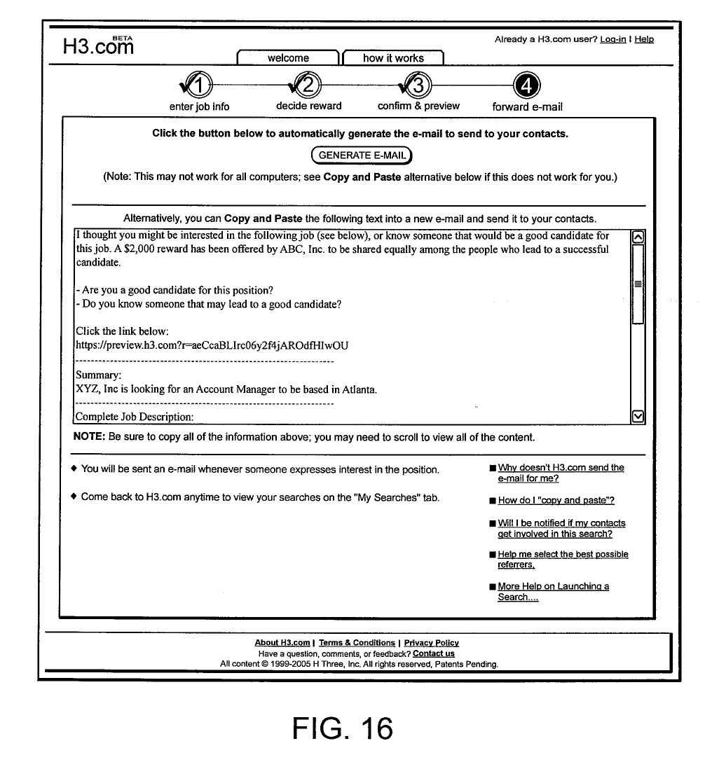

FIG. 16 depicts an example of a web page that includes the referral-identifier-incorporating URL. That web page provides the recruiter with the option of copying text that includes the URL and pasting it into e-mails sent by the recruiter to recipients to whom the recruiter wishes to refer the listing. The illustrated web page also provides a “generate e-mail” button that the recruiter can click to instruct the system to automatically generate an e-mail message containing the displayed text (including the URL). In one embodiment, when the “generate e-mail” button (or its equivalent) is clicked, the referral-tracking system will instruct the recruiter's web browser to invoke the recruiter's e-mail program (or other e-mail system) and instruct the e-mail program to generate the e-mail message. In an exemplary embodiment, the recruiter's e-mail program is invoked via the HTTP “mailto” command, i.e. embedded in a link in the displayed web page. Once the recruiter's e-mail program is invoked, the recruiter may then enter the e-mail addresses of one or more recicpients and send the e-mail message.

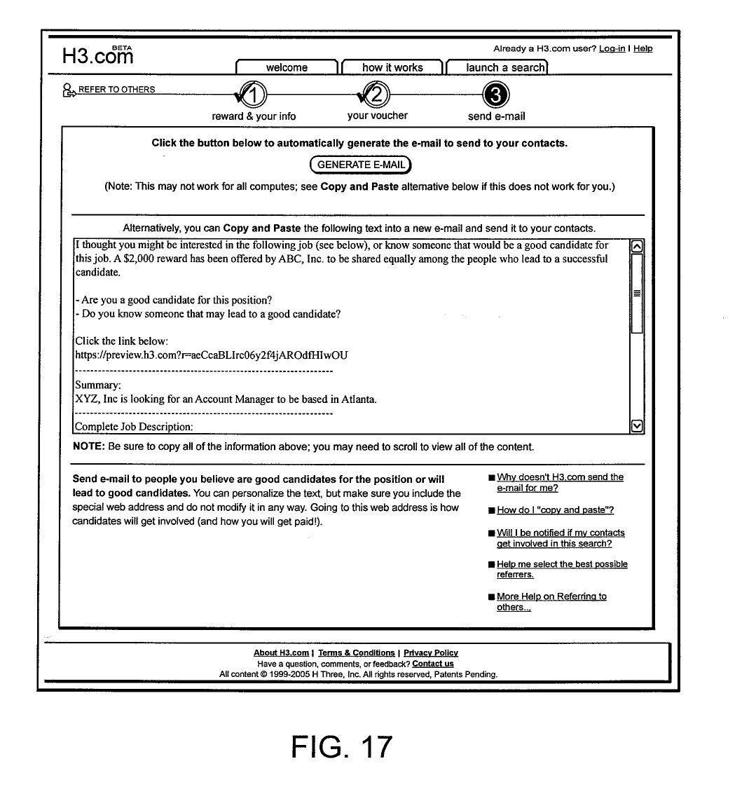

Similarly, exemplary embodiments may provide recipients who wish to make further referrals with the same option either to copy (from a web page displayed on the recipient's web browser) text including the URL incorporating the referral identifier and paste it into an e-mail message, or to generate automatically an e-mail message having that text using a “generate e-mail” button (or its equivalent). An illustrative web page displaying these options is shown in FIG. 17.

Now, one way in which sending the referral identifier by web-page transmission differs from sending it by e-mail is that web-page transmission does not provide automatic e-mail-address verification. In the e-mail approach to sending the referral identifier, the recruiter receives the referral identifier only if he has entered his e-mail address correctly, but the same cannot be said of the web-page approach, and such verification may be desirable. One way to provide it in the web-page approach involves implementing the listing-submission operation in multiple steps rather than the single step that FIG. 4's block 402 suggests.

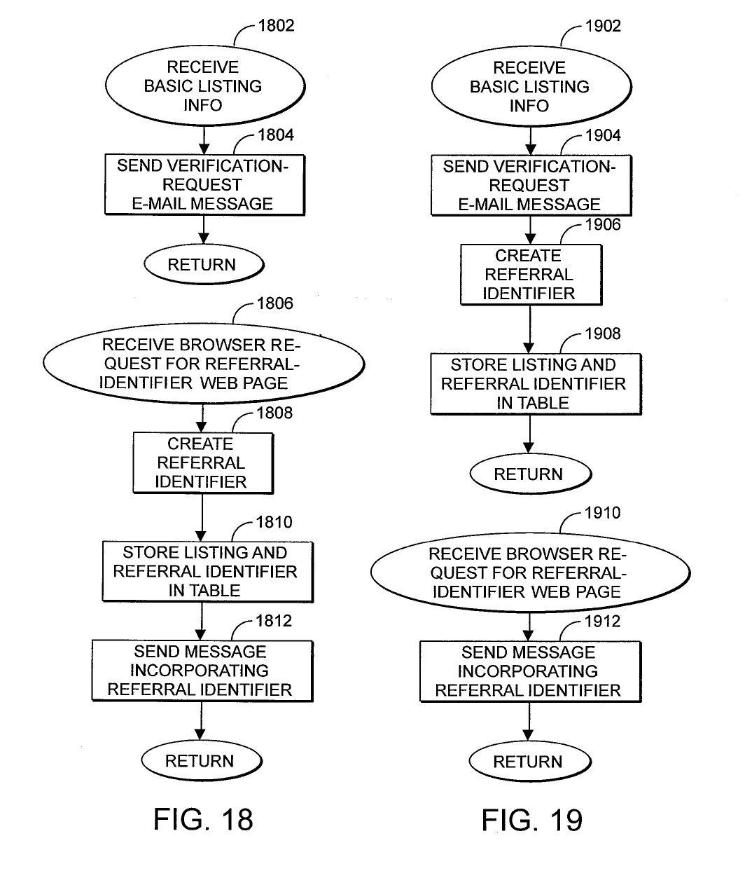

FIGS. 18 and 19 give examples. Those drawings are flow charts of exemplary routines for adding an additional, e-mail address-verification step to the listing-submission operation. As blocks 1802 and 1804 indicate, the server in the FIG. 18 approach responds to receipt of initial information by sending the recruiter an e-mail message containing the URL of a web page to which he must direct his browser in order to verify that the originally submitted e-mail address is correct. As blocks 1806, 1808, 1810, and 1812 indicate, it is only after receiving the resultant web page request that the system completes its response to the listing submission.

In the FIG. 19 approach, not only is the listing submission similarly divided into more than one step, but the server's response is divided into a portion that is triggered by the first submission step independently of whether the second submission step also occurs. In the approach of FIG. 19, the server not only sends the verification-request e-mail message in response to submission of the initial listing information but also creates the referral identifier and stores the listing and referral identifier in the table, as blocks 1906 and 1908 indicate. But, as blocks 1910 and 1912 indicate, the server does not send the referral identifier to the recruiter until the recruiter has sent the server the verification response by, e.g., clicking on a link in the verification-request e-mail message and thereby causing his browser to request the proper referral-identifier containing web page.

If desired, similar e-mail verification may also be employed prior to providing referral keys to recipients who wish to refer the listing to other recipients.

Other verification measures known in the art may also be employed prior to providing a recruiter or a recipient with a message containing a URL incorporating a referral identifier, or prior to accepting a recipient's expression of interest in a listing. For example, to prevent the automated creation of and response to listings, a referral-tracking system may display a web page containing a verification image (such as a captcha) and require a recruiter or recipient to enter text from the verification image.

By using the present invention's teachings, a referral-tracking system can adequately keep track of referral chains without imposing unattractive disclosure requirements. Therefore systems that employ the present invention's teachings can often elicit participation more effectively than conventional systems can.

What is claimed is:

1. A referral-tracking system comprising a computer system so configured that the referral-tracking system:
is operable, in response to input representing submission of a listing, to generate an identifier, associate that identifier with the listing, and send a user a message incorporating that identifier;
responds to receipt, from a requester, of a message representing an offer to forward the listing and incorporating an identifier associated by the referral-tracking system with the listing by, in at least some circumstances, generating as a child to that identifier a further identifier, associating the further identifier with the requester and the listing, and sending the requester a message that incorporates the further identifier; and
responds to a request for a set of ancestors and/or offspring of a given identifier associated by the referral-tracking system with the listing by determining the set and computing an output based upon the set.

2. A referral-tracking system as defined in claim 1 wherein the request for a set of ancestors and/or offspring of a given identifier results in at least some circumstances from an input indicating that the listing has been at least partially fulfilled.

3. A referral-tracking system as defined in claim 1 wherein the request for a set of ancestors and/or offspring of a given identifier results in at least some circumstances from a request for the status of a referral chain associated with the listing.

4. A referral-tracking system as defined in claim 1 that responds to receipt from an applicant of a message indicating interest in the listing and incorporating a received identifier associated by the referral-tracking system with the listing by, in at least some circumstances in which the listing is active, notifying the recruiter of the applicant's interest in the listing.

5. A referral-tracking system as defined in claim 1 wherein the message sent in response to submission of a listing is an e-mail message.

6. A referral-tracking system as defined in claim 5 wherein the e-mail message sent in response to submission of a listing includes a URL in which the identifier is incorporated.

7. A referral-tracking system as defined in claim 5 wherein the e-mail message sent in response to submission of a listing includes a URL in which the identifier is incorporated at least in part as a parameter.

8. A referral-tracking system as defined in claim 1 wherein the message sent in response to submission of a listing is a web page.

9. A referral-tracking system as defined in claim 8 wherein the web page sent in response to submission of a listing includes a URL in which the identifier is incorporated.

10. A referral-tracking system as defined in claim 8 wherein the web page sent in response to submission of a listing includes a URL in which the identifier is incorporated at least in part as a parameter.

11. A referral-tracking system as defined in claim 1 wherein the output is based on the set of ancestors and specifies award amounts for the requesters associated with at least some identifiers in that set.

12. A referral-tracking system as defined in claim 11 wherein the output specifies an award amount for each requester associated with an identifier in that set.

13. A referral-tracking system as defined in claim 1 wherein:
A) the output is based on the set of ancestors; and
B) the set of ancestors computed for a given referral identifier includes every ancestor of that identifier.

14. A referral-tracking system as defined in claim 1 wherein:
A) the listing whose submission is represented by the user input is a job listing; and
B) the message sent by the referral-tracking system refers to the job listing.

15. A referral-tracking system as defined in claim 1 wherein:
A) the input specifies a user e-mail address;
B) the referral-tracking system's response to the input includes sending to the user e-mail address a message that includes instructions for verification of the e-mail address;
C) the input includes providing a verification of the e-mail address in accordance with the instructions; and
D) the referral tracking system sends the user the message incorporating the identifier only if the user verifies the e-mail address in accordance with the instructions.

16. A storage medium containing machine instructions readable by a computer system to configure the computer system as a referral-tracking system that:
is operable, in response to input representing submission of a listing, to generate an identifier, associate that identifier with the listing, and send a user a message incorporating that identifier;
responds to receipt, from a requester, of a message representing an offer to forward the listing and incorporating an identifier associated by the referral-tracking system with the listing by, in at least some circumstances, generating as a child to that identifier a further identifier, associating the further identifier with the requester and the listing, and sending the requester a message that incorporates the further identifier; and
responds to a request for a set of ancestors and/or offspring of a given identifier associated by the referral-tracking system with the listing by determining the set and computing an output based upon the set.

17. A storage medium as defined in claim 16 wherein the request for a set of ancestors and/or offspring of a given identifier results in at least some circumstances from an input indicating that the listing has been at least partially fulfilled.

18. A storage medium as defined in claim 16 wherein the request for a set of ancestors and/or offspring of a given identifier results in at least some circumstances from a request for the status of a referral chain associated with the listing.

19. A storage medium as defined in claim 16 wherein the referral-tracking system responds to receipt from an applicant of a message indicating interest in the listing and incorporating a received identifier associated by the referral-tracking system with the listing by, in at least some circumstances in which the listing is active, notifying the recruiter of the applicant's interest in the listing.

20. A storage medium as defined in claim 16 wherein the message sent in response to submission of a listing is an e-mail message.

21. A storage medium as defined in claim 20 wherein the e-mail message sent in response to submission of a listing includes a URL in which the identifier is incorporated.

22. A storage medium as defined in claim 20 wherein the e-mail message sent in response to submission of a listing includes a URL in which the identifier is incorporated at least in part as a parameter.

23. A storage medium as defined in claim 16 wherein the message sent in response to submission of a listing is a web page.

24. A storage medium as defined in claim 23 wherein the web page sent in response to submission of a listing includes a URL in which the identifier is incorporated.

25. A storage medium as defined in claim 23 wherein the web page sent in response to submission of a listing includes a URL in which the identifier is incorporated at least in part as a parameter.

26. A storage medium as defined in claim 16 wherein the output is based on the set of ancestors and specifies award amounts for the requesters associated with at least some identifiers in that set.

27. A storage medium as defined in claim 26 wherein the output specifies an award amount for each requester associated with an identifier in that set.

28. A storage medium as defined in claim 16 wherein:
A) the output is based on the set of ancestors and
B) the set of ancestors computed for a given referral identifier includes every ancestor of that identifier.

29. A storage medium as defined in claim 16 wherein:
A) the listing whose submission is represented by the user input is a job listing; and
B) the message sent by the referral-tracking system refers to the job listing.

30. A storage medium as defined in claim 16 wherein:
A) the input specifies a user e-mail address;
B) the referral-tracking system's response to the input includes sending to the user e-mail address a message that includes instructions for verification of the e-mail address;
C) the input includes providing a verification of the e-mail address in accordance with the instructions; and
D) the referral tracking system sends the user the message incorporating the identifier only if the user verifies the e-mail address in accordance with the instructions.
